(19) United States
(12) Patent Application Publication
(10) Pub. No.: US 2013/0213023 A1
(43) Pub. Date: Aug. 22, 2013

(54) HYDRAULIC SYSTEM HAVING LOW-SPEED OPERATING MODE

(71) Applicants: Peter K. Eckstein, East Peoria, IL (US); Timothy L. Hand, Metamora, IL (US); Mohammad A. Hussain, Edwards, IL (US); Joseph M. Huelsmann, Washington, IL (US); David D. Tallon, Washington, IL (US); Scott A. Keeley, Dunlap, IL (US); Vance M. Buatte, Danvers, IL (US)

(72) Inventors: Peter K. Eckstein, East Peoria, IL (US); Timothy L. Hand, Metamora, IL (US); Mohammad A. Hussain, Edwards, IL (US); Joseph M. Huelsmann, Washington, IL (US); David D. Tallon, Washington, IL (US); Scott A. Keeley, Dunlap, IL (US); Vance M. Buatte, Danvers, IL (US)

(21) Appl. No.: 13/402,446

(22) Filed: Feb. 22, 2012

(51) Int. Cl. F15B 15/18

(52) U.S. Cl. 60/327; 60/459

(57) ABSTRACT

A hydraulic system is disclosed for use with a machine. The hydraulic system may have a tank, a motor with a fluid inlet and a fluid outlet, and a pump configured to draw fluid from the tank and discharge the fluid at elevated pressures to the motor. An output of the pump is adjustable to regulate a speed of the motor. The hydraulic system may also have a low-speed valve located between the fluid outlet of the motor and the tank. The low-speed valve may be configured to reduce a positive speed of the motor below a lowest positive speed attainable through control of pump output.

### TECHNICAL FIELD

The present disclosure relates generally to a hydraulic system and, more particularly, to a hydraulic system having a low-speed mode of operation.

### BACKGROUND

Engine-driven machines such as, for example, on-highway trucks, dozers, loaders, excavators, motor graders, and other types of heavy equipment typically include one or more different hydraulic systems that are used to accomplish a variety of tasks. These hydraulic systems can include, among others, a cooling system, an implement system, a drive system, a material handling system, and a lubrication system. During completion of an assigned task, actuators within the hydraulic systems can be commanded to move at relatively high speeds and at relatively low speeds. The speeds of the actuators can be controlled by adjusting a speed of a pump that delivers pressurized fluid to the actuators or by controlling an amount and/or pressure of fluid supplied to the actuator, for example by dumping fluid from the system upstream of the actuators.

In a cooling system having a fan propelled by a fluid-driven motor, the speed of the fan can be controlled based on a temperature of an associated engine, a temperature of coolant passing through the engine, a temperature of lubricating oil within the engine, a temperature of combustion air entering the engine, and/or an ambient temperature. As one or more of these temperatures increases, the fan can be caused to speed up and enhance cooling of the engine. Similarly, as one or more of these temperatures decreases, the speed of the fan can likewise be reduced to decrease cooling, to increase efficiency, and/or to conserve fuel.

In some situations, it may not be possible to sufficiently slow the speed of a hydraulic actuator (e.g., the motor propelling the fan). In particular, the pump driving the actuator may have a minimum speed and/or displacement that results in a corresponding minimum speed of the actuator that, in some situations, may not be slow enough. Likewise, the system may be capable of dumping a maximum amount of pressure or flow upstream of the actuator, resulting in a corresponding fixed minimum speed that may not be slow enough for some applications. In addition, when the speed of the actuator becomes too low, the speed can become unstable and unreliable.

The disclosed hydraulic system is directed to overcoming one or more of the problems set forth above and/or other problems of the prior art.

### SUMMARY

In one aspect, the present disclosure is directed to a hydraulic system. The hydraulic system may include a tank, a motor having a fluid inlet and a fluid outlet, and a pump configured to draw fluid from the tank and discharge the fluid at elevated pressures to the motor. An output of the pump is adjustable to regulate a speed of the motor. The hydraulic system may also include a low-speed valve located between the fluid outlet of the motor and the tank. The low-speed valve may be configured to reduce a positive speed of the motor below a lowest positive speed attainable through control of pump output.

In another aspect, the present disclosure is directed to a method of operating a hydraulic system. The method may include pressurizing a fluid with a pump, and directing a flow of the pressurized fluid to an inlet of a motor to drive the motor. The method may also include adjusting an operation of the pump to reduce a speed of the motor, and selectively activating a low-speed valve fluidly connected to an outlet of the motor to further reduce the speed of the motor.

### BRIEF DESCRIPTION OF THE DRAWINGS

FIG. 1 is a pictorial illustration of an exemplary disclosed machine;

FIG. 2 is a schematic illustration of an exemplary disclosed hydraulic system that may be used in conjunction with the machine of FIG. 1; and

FIG. 3 is a flowchart depicting an exemplary disclosed method of operating the hydraulic system of FIG. 2.

### DETAILED DESCRIPTION

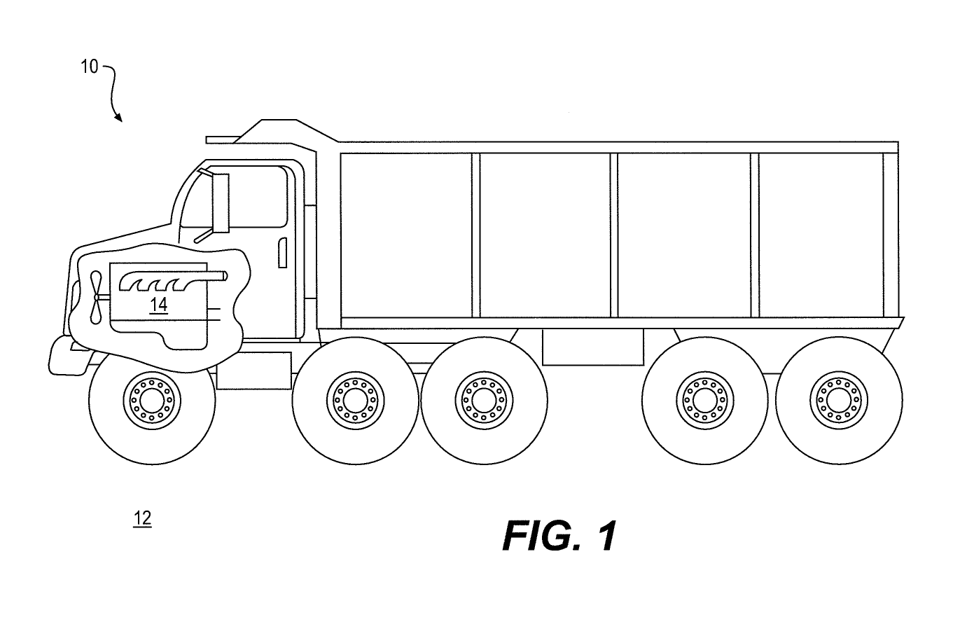

FIG. 1 illustrates an exemplary machine 10 performing a particular function at a worksite 12. Machine 10 may embody a stationary or mobile machine, with the particular function being associated with an industry such as mining, construction, farming, transportation, power generation, oil and gas, or another industry known in the art. For example, machine 10 may be a mobile machine such as the on-highway truck depicted in FIG. 1, a dozer, a motor grader, or a wheel loader. Machine 10 may alternatively embody a stationary machine, such as a generator set or a pumping mechanism. Machine 10 may embody any suitable operation-performing machine.

Machine 10 may be equipped with an engine 14 that provides power to one or more onboard hydraulic systems (e.g., to a cooling system, a drive system, a tool system, a lubrication system, etc.). During the performance of most tasks, power from engine 14 may be split between the different hydraulic systems to drive their operations. Accordingly, engine 14 may be sized to provide enough power to satisfy a maximum combined demand of the different hydraulic systems. Engine 14 may provide power to the hydraulic systems in the form of a rotating mechanical output, which the different hydraulic systems can subsequently convert to hydraulic power in the form of pressurized fluid circulated through the systems.

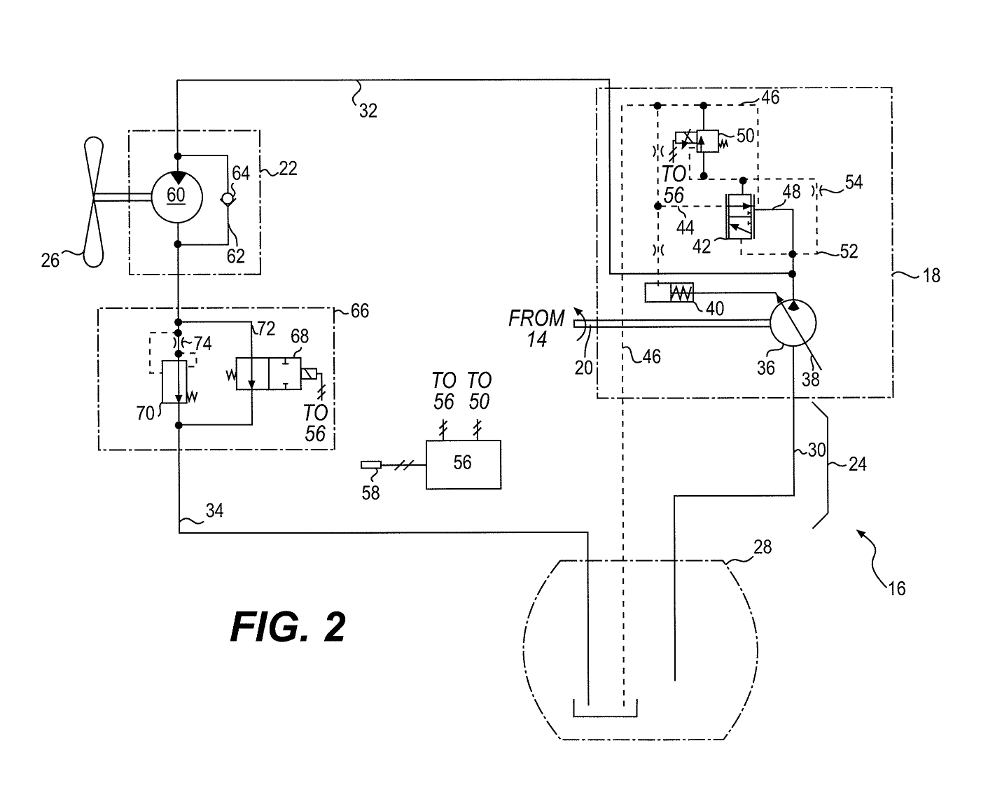

An exemplary hydraulic system 16 is illustrated in FIG. 2. In this embodiment, hydraulic system 16 is used for cooling engine 14. Hydraulic system 16 may include, among other things, a pump 18 mechanically connected directly to an output 20 of engine 14, a motor 22 fluidly connected to pump 18 by an open circuit 24, and a fan 26 mechanically connected to and driven by motor 22. Engine 14 may drive pump 18 via output 20 to draw in low-pressure fluid from a tank 28 and discharge the fluid at an elevated pressure. Motor 22 may receive and convert the pressurized fluid to mechanical power that drives fan 26 to generate a flow of air. The flow of air may be used to cool engine 14 directly and/or indirectly by way of a heat exchanger (not shown), as desired.

Pump 18 may be any type of pump known in the art, such as a unidirectional or over-center pump having a fixed or variable displacement. For example, pump 18 may embody a rotary or piston-driven pump having a crankshaft (not shown) connected to engine 14 via output 20 such that a rotation of engine 14 results in a corresponding pumping motion of pump 18. The pumping motion of pump 18 may function to draw in low-pressure fluid from tank 28 via a low-pressure passage 30, and discharge the fluid at an elevated pressure to motor 22 via a high-pressure passage 32. After passing through motor 22, the fluid may return to tank 28 via a drain passage 34. Low-pressure passage 30, high-pressure passage 32, and drain passage 34 together may form circuit 24. Pump 18 may be dedicated to supplying pressurized fluid to only motor 22 via high-pressure passage 32 or, alternatively, may also supply pressurized fluid to other hydraulic circuits associated with machine 10 (e.g., to hydraulic circuits associated with the tool system, the drive system, the lubrication system, etc.), if desired. Similarly, pump 18 may be dedicated to drawing low-pressure fluid from only tank 30 via low-pressure passage 28 or, alternatively, may also draw low-pressure fluid from other tanks and/or circuits of machine 10, if desired.

In the particular embodiment of FIG. 2, pump 18 includes a unidirectional, variable-displacement pumping mechanism 36 that is pressure-controlled via a solenoid-operated valve arrangement. Specifically, pumping mechanism 36 may equipped with a stroke-adjusting mechanism 38, for example a swashplate, a position of which is hydro-mechanically adjusted based on, among other things, a desired speed of fan 26 (or a desired cooling of engine 14 facilitated by fan 26) to thereby vary an output (e.g., a discharge rate) of pump 18. The displacement of pumping mechanism 36 may be adjusted from a minimum displacement position at which a minimum amount of fluid is discharged from pump 18 for every revolution of pump 18, to a maximum displacement position at which fluid is discharged from pump 18 at a maximum rate into high-pressure passage 32. A displacement actuator 40 may be mechanically connected to stroke-adjusting mechanism 38 and configured to move stroke-adjusting mechanism 38 when filled with pressurized fluid. Displacement actuator 40 may be spring biased toward the minimum displacement position.

The movement of displacement actuator 40 may be controlled by a pilot-operated valve element 42. In particular, valve element 42 may be fluidly connected to displacement actuator 40 via a passage 44, to tank 28 via a passage 46, and to pumping mechanism 38 via a passage 48. Valve element 42 may be movable between a first position (shown in FIG. 2) at which displacement actuator 40 is fluidly communicated with tank 28 via passages 44 and 46, and a second position at which displacement actuator 40 is fluidly communicated with the output of pumping mechanism 38 via passages 44 and 48. When displacement actuator 40 is fluidly communicated with tank 24, displacement actuator 40 may be biased toward the maximum displacement position. When displacement actuator 40 is fluidly communicated with the output of pumping mechanism 38, displacement actuator 40 may move toward the minimum displacement position.

A solenoid-operated valve element 50 may control movement of valve element 42 between the first and second positions. In particular, a pilot passage 52 may connect the output of pumping mechanism 38 (i.e., may connect passage 48) to opposing ends of valve element 42, and a restricted orifice 54 may be disposed within pilot passage 52 at a location between passage 48 and a first end of valve element 42. Valve element 50 may be fluidly connected between the first end of valve element 42 and passage 46 that leads to tank 28, and controllably moved from a flow-blocking position toward a flow-passing position when energized. When valve element 50 is in the flow-blocking position, both ends of valve element 42 may be exposed to fluid at about the same pressure and valve element 42 may be biased toward its second position by an associated spring. When valve element 50 is in the flow-passing position, the first end of valve element 42 may be connected to tank 28 allowing restricted orifice 54 to create a pressure differential that moves valve element 42 toward its first position. Valve element 50 may be moved to any position between its flow-passing and flow-blocking positions when energized by a controller 56.

Controller 56 may embody a single or multiple microprocessors, field programmable gate arrays (FPGAs), digital signal processors (DSPs), etc. that include a means for controlling an operation of hydraulic system 16 in response to signals received from one or more sensors 58. Numerous commercially available microprocessors can be configured to perform the functions of controller 56. It should be appreciated that controller 56 could readily embody a microprocessor separate from that controlling other machine-related functions, or that controller 56 could be integral with a machine microprocessor and be capable of controlling numerous machine functions and modes of operation. If separate from the general machine microprocessor, controller 56 may communicate with the general machine microprocessor via datalinks or other methods. Various other known circuits may be associated with controller 56, including power supply circuitry, signal-conditioning circuitry, actuator driver circuitry (i.e., circuitry powering solenoids, motors, or piezo actuators), and communication circuitry.

Sensor(s) 58 may be configured to generate signals indicative of one or more different engine temperatures. These engine temperatures could include, for example, coolant temperatures, lubricating oil temperatures, engine block temperatures, exhaust temperatures, boost temperatures, ambient air temperatures, or other temperatures. Sensor(s) 58 may direct the signals to controller 56 for further processing.

Motor 22 may include a fixed- or variable-displacement, rotary- or piston-type hydraulic actuator 60 that is movable by an imbalance of pressures acting on a driven element (not shown), for example on an impeller or a piston. Fluid pressurized by pump 18 may be directed into motor 22 via high-pressure passage 32 and returned from motor 22 to tank 28 via drain passage 34. The direction of pressurized fluid to one side of the driven element and the draining of fluid from an opposing side of the driven element may create a pressure differential across the driven element that causes the driven element to move or rotate. The direction and rate of fluid flow through motor 22 may determine the rotational direction and speed of motor 22 and fan 26, while the pressure imbalance across the driven element may determine the torque output.

An anti-cavitation passage 62 having a check valve 64 may be disposed within motor 22 and configured to connect drain passage 34 (i.e., the output of hydraulic actuator 60) directly with high-pressure passage 32 (i.e., the input of hydraulic actuator 60) under some conditions. In particular, there may be some situations where fan 26 drives motor 22 to move faster than otherwise possible for a given flow of fluid entering hydraulic actuator 60. These situations may occur, for example, during slowdown of motor 22. When motor 22 is driven by fan 26, motor 22 may act like a pump and generate a pressure output greater than a pressure input. If left unchecked, this could cause motor 22 to cavitate. Anti-cavitation passage 62, however, may allow the discharge of hydraulic actuator 60 to circulate back to its input when a pressure at the output is greater than at the input, thereby helping to reduce the likelihood of cavitation.

Fan 26 may be disposed proximate one or more liquid-to-air or air-to-air heat exchangers (not shown) and configured to produce a flow of air directed through channels of the exchanger for heat transfer with coolant and/or combustion air therein. Fan 26 may include a plurality of blades connected to motor 22 and be driven by motor 22 at a speed corresponding to a desired flow rate of air and/or a desired engine temperature.

As described above, controller 56 may be used to adjust a displacement of pump 18, thereby changing a speed of motor 22 and fan 26 and a resulting cooling of engine 14. In some situations, however, this control over fan speed may be insufficient to meet desired conditions of engine 14. For example, the minimum positive speed of fan 26 achievable through pump control may be about 400-500 rpm, which may not be slow enough for some applications (e.g., during overnight idling in extremely low ambient temperatures). In these applications, an additional way to reduce fan speed even lower may be desired. For this reason, controller 56 may be configured to selectively activate a low-speed mode of operation when necessary. It should be noted that it may be desirable, for safety reasons, to always keep fan 26 rotating at some positive speed during operation of engine 14.

To activate the low-speed mode of operation, controller 56 may selectively generate a control signal directed to a low-speed valve 66 located downstream of motor 22 (i.e., between motor 22 and tank 28). Low-speed valve 66 may include a control element 68 and a pressure-compensating element (PCE) 70 that are fluidly interconnected. Control element 68 may be disposed within a bypass passage 72 having an inlet fluidly connected to drain passage 34 at a location upstream of PCE 70, and an outlet fluidly connected to drain passage 34 at a location downstream of PCE 70. Control element 68 may be movable from a default flow-passing position (shown in FIG. 2) against a spring bias to a flow-blocking position in response to an electronic signal from controller 56. When control element 68 is in the flow-passing position during normal operations, low-speed valve 66 may have little or no affect on the operation of hydraulic system 14 (i.e., fan speed may be unaffected by low-speed valve 66 when control element 68 is in the flow-passing position) and all discharge from motor 22 may pass through bypass passage 72. During the low-speed mode of operation, however, controller 56 may selectively cause control element 68 to snap to the flow-blocking position, thereby blocking bypass passage 72 and causing all discharge from motor 22 to pass through PCE 70.

PCE 70 may be located just downstream of a restricted orifice 74 and have opposing pilot passages that are fluidly connected to the inlet and outlet of restricted orifice 74. Based on a pressure differential across restricted orifice 74, PCE 70 may move between flow-passing (shown in FIG. 2) and flow-blocking positions to maintain a desired rate of fluid flowing through drain passage 34 (i.e., through motor 22). In one embodiment, this desired flow rate of fluid may be about 3-4 L/m and result in a reduced fan speed of about 100-125 rpm (i.e., about 60-75% lower than possible through adjustment control of pump 18 alone).

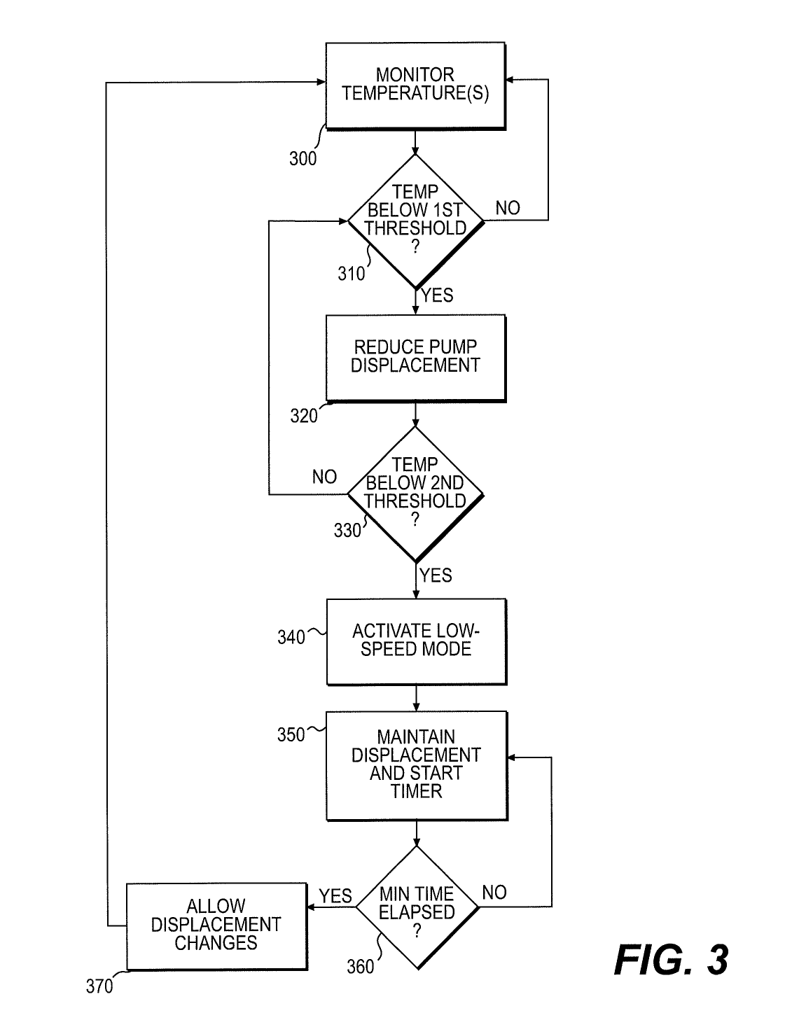

FIG. 3 illustrates a flowchart associated with operation of hydraulic system 14 during the low-speed mode of operation. FIG. 3 will be discussed in more detail in the following section to further illustrate the disclosed concepts.

### INDUSTRIAL APPLICABILITY

The disclosed hydraulic system may be applicable to any machine where accurate control of a motor at low speeds is desired. The disclosed hydraulic system may provide for accurate motor control through the novel use of a pressure-compensated low-speed valve located at an outlet of the motor. Operation of hydraulic system 16 will now be described with respect to FIG. 3.

During the normal operational mode of machine 10 after engine 14 has been started and warmed to normal operating temperatures, engine 14 may drive pump 18 to draw in fluid from tank 28 via low-pressure passage 30 and to pressurize the fluid. The pressurized fluid may be discharged from pump 18 at maximum flow rate into high-pressure passage 32 and be directed into motor 22. As the pressurized fluid passes through motor 22, hydraulic power in the fluid may be converted to mechanical power used to rotate fan 26 at maximum speed. As fan 26 rotates, a flow of air may be generated that facilitates cooling of engine 14. Fluid exiting motor 22, having been reduced in pressure, may be directed into tank 28 via drain passage 34 to repeat the cycle.

As the temperature(s) of engine 14 changes, due to changing ambient or loading conditions, controller 56 may monitor the changes in temperature(s) via sensor 58 (Step 300). Controller 56 may then compare the monitored temperature(s) to a first threshold temperature (Step 310). In a first embodiment, the first threshold temperature may be associated with a jacket water temperature and have a value of about 100-105° C. In a second embodiment, the first threshold temperature may be associated with a combustion air (i.e., boost) temperature and have a value of about 53-57° C. In a third embodiment, the first threshold temperature may be associated with a tool oil temperature and have a value of about 88-92° C. In a fourth embodiment, any combination of these first threshold temperatures may be simultaneously utilized by controller 56 for comparison with one or more different sensed temperatures, if desired.

As long as the monitored temperature(s) is above the first threshold temperature(s), operation may continue normally, as described above, and control may return to step 300. If at step 310, however, controller 56 determines that the temperature(s) of engine 14 is below the first threshold temperature (s), controller 56 may conclude that engine 14 is cooling more than desired and adjust the displacement of pump 18 accordingly (Step 320). That is, controller 56 may proportionally reduce the displacement of pump 18 as the temperature(s) of engine 14 falls below the first threshold temperature until a minimum displacement position of pump 18 is reached. At this point in time in an exemplary embodiment, pump 18 may still be generating about 10-15 L/m of fluid flow and fan 26 may still be rotating at about 400-500 rpm to cool engine 14. The displacement of pump 18 should reach its minimum position when the monitored temperature(s) of engine 14 is about 90-95° C. (jacket water temperature), about 48-52° C. (combustion air temperature), and/or about 83-87° C. (tool oil temperature).

Controller 56 may continue monitoring the temperature(s) of engine 14 and compare the monitored temperature(s) to a lower second threshold temperature (Step 330). In one embodiment, the second threshold temperature may be associated with jacket water temperature and have a value of about 70° C. It is contemplated, however, that different or additional second threshold temperatures may be used for comparison, if desired. As long as the temperature(s) of engine 14 remains below the first threshold temperature and above the second threshold temperature, control may loop through steps 310-330, as the temperature(s) of engine 14 may be within an acceptable range. However, when the temperature of engine 14 falls below the second threshold temperature, controller 56 may conclude that engine 14 is too cold for desired operation, and activate the low-speed mode of operation to further reduce cooling of engine 14 (Step 340). That is, controller 56 may generate an electronic signal directed to control element 68 of low-speed valve 66 causing control element 68 to snap to its flow-blocking position. When control element 68 snaps to its flow-blocking position, all discharge from motor 18 may be forced through PCE 70, thereby limiting the flow through motor 18 to about 3-4 L/m in an exemplary embodiment. This limited flow rate through motor 18 may result in a step reduction in fan speed of about 100-125 rpm.

When PCE 70 begins to limit flow through motor 18, the inertia of fan 26 may initially drive hydraulic actuator 60 to act as a pump, quickly generating an increase in pressure at the outlet of hydraulic actuator 60. This pressurized fluid may circulate back around to the inlet of hydraulic actuator 60 via bypass passage 62 and check valve 64, until fan 26 has slowed sufficiently and the pressures at the inlet and outlet of hydraulic actuator 60 have normalized somewhat.

At this point in time, the pressure of fluid within high-pressure passage 32 will have increased due to the restriction placed on fluid flow by PCE 70, normally causing pump 18 to adjust its displacement. Such an action at this time, however, could result in instabilities in PCE 70. Accordingly, controller 56, after activating the low-speed mode of operation, may cause pump 18 to maintain its current displacement position for at least a minimum amount of time (Step 350). That is, controller 56 may start a counter and wait until the minimum amount of time has elapsed (Step 360) before allowing pump 18 to function normally and vary its displacement in response to changing pressures (Step 370). In one embodiment, the minimum amount of time may be about 30 seconds. Control may then return to step 300.

It should be noted that hydraulic system 16 may function in a reverse manner as the temperatures of engine 14 increase after initial start up. For example, upon startup, if temperatures of engine 14 are below the first threshold temperature, controller 56 may first adjust the displacement of pump 18 to its minimum position to drive fan 26 at about 400-500 rpm. In addition, if the temperatures of engine 14 are below the second threshold temperature, controller 56 may activate the low-speed mode of operation to further reduce fan speed to about 100-125 rpm. In some embodiments, controller 56 may delay a period of time, for example about 10 seconds, after reducing the displacement of pump 18 before activating the low-speed mode of operation. Then, as engine 14 begins to warm and temperatures climb past the second threshold temperature, controller 56 may deactivate the low-speed mode of operation. As the temperatures climb even further, controller 56 may proportionally increase the displacement of pump 18 until the temperatures surpass the first threshold temperature and fan 26 is spinning at its maximum speed.

The disclosed hydraulic system may be capable of reducing a minimum positive speed of a motor in a controllable manner. This capability may allow for some rotation of the motor to continue, but at a level much lower than normally possible through pump control alone. In addition, the stability of the resulting speed may allow for reliable performance of the associated machine.

It will be apparent to those skilled in the art that various modifications and variations can be made to the disclosed hydraulic system. For example, although pump 18 has been described as an electronic pressure-controlled type of pump, it is contemplated that the disclosed low-pressure valve 66 and associated control method could likewise be applied to a system having a constant pressure controlled pump, a remote pressure controlled pump, or another type of pump, as desired. Other embodiments will be apparent to those skilled in the art from consideration of the specification and practice of the disclosed hydraulic system. It is intended that the specification and examples be considered as exemplary only, with a true scope being indicated by the following claims and their equivalents.

What is claimed is:

1. A hydraulic system, comprising:
a tank;
a motor having a fluid inlet and a fluid outlet;
a pump configured to draw fluid from the tank and discharge the fluid at elevated pressures to the motor, wherein an output of the pump is adjustable to regulate a speed of the motor; and
a low-speed valve located between the fluid outlet of the motor and the tank, the low-speed valve being configured to reduce a positive speed of the motor below a lowest positive speed attainable through control of pump output.

2. The hydraulic system of claim 1, wherein the output of the pump is at least one of a pressure and a flow rate.

3. The hydraulic system of claim 2, wherein the output of the pump is adjusted through displacement control of the pump.

4. The hydraulic system of claim 3, further including a fan connected to and driven by the motor, wherein:
the fan is configured to cool an engine; and
the speed of the motor is regulated based on a temperature of the engine.

5. The hydraulic system of claim 4, further including:
a temperature sensor configured to generate a signal indicative of a temperature of the engine; and
a controller in communication with the temperature sensor, the pump, and the low-speed valve, the controller being configured to:
adjust operation of the pump to reduce a speed of the fan when the signal indicates the engine temperature below a first threshold value; and
activate the low-speed valve when the signal indicates the engine temperature is below a lower second threshold value.

6. The hydraulic system of claim 5, wherein the temperature sensor is associated with at least one of a coolant, a lubrication, a hydraulic tool oil, and an ambient condition of the engine.

7. The hydraulic system of claim 5, wherein the controller is configured to adjust operation of the pump to proportionally reduce a speed of the fan as the temperature of the engine falls.

8. The hydraulic system of claim 7, wherein activation of the low-speed valve results in a step-change in the speed of the fan.

9. The hydraulic system of claim 8, wherein normal operations of the pump and motor are substantially unaffected by the low-speed valve.

10. The hydraulic system of claim 8, wherein the controller is configured to hold a displacement of the pump at a minimum position for at least a threshold amount of time after activation of the low-speed valve.

11. The hydraulic system of claim 1, wherein the low-speed valve includes:
a control element having a default flow-passing position and a controlled flow-blocking position; and
a pressure-compensating element configured to pass a fixed rate of fluid when the control element is in the controlled flow-blocking position.

12. The hydraulic system of claim 1, wherein the low-speed valve is configured to reduce a speed of the motor by about 60-75% below a minimum positive speed possible through output control of the pump.

13. A method of operating a hydraulic system, comprising:
pressurizing a fluid with a pump;
directing a flow of the pressurized fluid to an inlet of a motor to drive the motor;
adjusting an operation of the pump to reduce a speed of the motor; and
selectively activating a low-speed valve fluidly connected to an outlet of the motor to further reduce the speed of the motor.

14. The method of claim 13, further including sensing an operating parameter of an associated engine, wherein operation of the pump is adjusted and the low-speed valve are selectively activated based on a value of the operating parameter.

15. The method of claim 14, wherein adjusting the operation of the pump including reducing a displacement of the pump when the value of the operating parameter falls below a first threshold value.

16. The method of claim 15, wherein selectively activating the low-speed valve includes selectively activating the low-speed valve when the value of the operating parameter falls below a lower second threshold value.

17. The method of claim 16, wherein:
reducing the displacement of the pump reduces the speed of the motor in a proportional manner as the value of the operating parameter falls; and
selectively activating the low-speed valve causes the speed of the motor to reduce in a step-wise manner.

18. The method of claim 17, further including maintaining a minimum displacement position of the pump for at least a threshold period of time after activation of the low-speed valve.

19. The method of claim 16, wherein:
the operating parameter is a temperature of the engine; and
the motor is configured to drive a fan that cools the engine.

20. A machine, comprising:
an engine configured to generate a power output; and
a cooling system configured to cool the engine, the cooling system including:
a tank;
a motor having a fluid inlet and a fluid outlet;
a fan connected to the motor;
a pump configured to draw fluid from the tank and discharge the fluid at elevated pressures to the motor;
a low-speed valve located between the fluid outlet of the motor and the tank; and
a controller in communication with the pump and the low-speed valve, the controller being configured to:
detect a temperature of the engine;
adjust operation of the pump to reduce a positive speed of the motor when the temperature of the engine falls below a first threshold value; and
activate the low-speed valve to further reduce the positive speed of the motor when the temperature of the engine falls below a second threshold value less than the first threshold value.
